(19) United States
(12) Patent Application Publication
(10) Pub. No.: US 2005/0131995 A1
(43) Pub. Date: Jun. 16, 2005

(54) Autonomic evaluation of web workload characteristics for self-configuration memory allocation

(75) Inventors: Jeffery S. Chase, Durham, NC (US); Ronald R. Doyle, Raleigh, NC (US); Steven D. Ims, Cary, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/733,659

(22) Filed: Dec. 11, 2003

(51) Int. Cl. G06F 15/16

(52) U.S. Cl. 709/203; 711/118

(57) ABSTRACT

The present invention is a system, method and apparatus for selecting a cache memory allocation to provide an optimized target cache hit rate in a caching component of a content delivery system. The method of the invention can include identifying a current cache size and a contemporaneously experienced trace footprint. A hit rate produced in response to the current cache size and the contemporaneously experienced trace footprint can be determined and a Zipf alpha coefficient can be computed for the current cache size, trace footprint and hit rate. An optimal hit rate can be selected and an optimal cache size for the Zipf alpha coefficient, trace footprint and optimal hit rate can be computed in consequence. Once the optimal cache size has been computed, the cache memory allocation can be modified based upon the optimal cache size.

### BACKGROUND OF THE INVENTION

1. Statement of the Technical Field

The present invention relates to memory allocation for caching content in a web caching systems, including a content delivery network and more particularly to the autonomic evaluation of Web workload characteristics to facilitate the configuration of cache size for web caches.

2. Description of the Related Art

In the prototypical content delivery system, content can be delivered from an origin server to a community of content consuming clients. Content typically can be delivered according to a request-response paradigm in which the content consuming clients initiate a request for content to which one or more origin servers can respond with the requested content. Generally, one or more content caches can be disposed in the intermediate communications path between the content consuming clients and content servers in order to enhance the responsiveness of the servers to any single client request and to reduce the processing burden placed upon the origin server.

Observations of content request patterns drive the design choices and policies for all of these components of a content delivery architecture. In particular, a number of studies indicate that requests to retrieve static Web objects follow a Zipf-like popularity distribution. Specifically, in accordance with Zipf, the probability pᵢ of a request for the i^{th} most popular document is proportional to 1/i^{α} for some parameter α where α is a number greater than zero and generally less than unity. In this Zipf-like distribution, a large number of object requests typically target the most popular object sources and the most popular objects within those sources. The Zipf-like distribution, however, also includes a long, heavy tail of less popular objects with poor reference locality.

Notably, higher a values increase the concentration of requests on the most popular objects. One implication of the Zipf-like behavior of the Web is that caching is highly effective for the most popular static, and thus cacheable objects, assuming that popularity dominates rate of change. Unfortunately, caching is less effective in respect to the heavy tail of the distribution, which comprises a significant fraction of requests. Hence, Web cache effectiveness typically improves only logarithmically with the size of the cache, measured either by capacity or by user population. Of course, establishing an optimal memory allocation for a cache can vary with the value of the α parameter and the footprint of processed Web traces.

Predicting an optimal memory allocation for a cache at design time, however, can be difficult for most. Moreover, whereas optimally selecting a suitable cache size can be problematic generally, in an autonomic system, the problem can be particularly acute. For the uninitiated, autonomic computing systems self-regulate, self-repair and respond to changing conditions, without requiring any conscious effort on the part of the computing system operator. To that end, the computing system itself can bear the responsibility of coping with its own complexity. The crux of autonomic computing relates to eight principal characteristics:

I. The system must “know itself” and include those system components which also possess a system identify.

II. The system must be able to configure and reconfigure itself under varying and unpredictable conditions.

III. The system must never settle for the status quo and the system must always look for ways to optimize its workings.

IV. The system must be self-healing and capable of recovering from routine and extraordinary events that might cause some of its parts to malfunction.

V. The system must be an expert in self-protection.

VI. The system must know its environment and the context surrounding its activity, and act accordingly.

VII. The system must adhere to open standards.

VIII. The system must anticipate the optimized resources needed while keeping its complexity hidden from the user.

Thus, in keeping with the principles of autonomic computing, memory allocations for cache size ought to change with the changing footprint of Web traces and with changing α parameter values.

### SUMMARY OF THE INVENTION

The present invention addresses the deficiencies of the art in respect to the configuration of cache memory in content delivery systems, including Web caches, and provides a novel and non-obvious method, system and apparatus for selecting a cache memory allocation to provide an optimized target cache hit rate in a content delivery system. In a preferred aspect of the invention, a method for selecting a cache memory allocation to provide an optimized target cache hit rate can include identifying a current cache size and a contemporaneously experienced trace footprint. A hit rate produced in response to the current cache size and the contemporaneously experienced trace footprint can be determined and a Zipf alpha coefficient can be computed for the current cache size, trace footprint and hit rate. An optimal hit rate can be selected and an optimal cache size for the Zipf alpha coefficient, trace footprint and optimal hit rate can be computed in consequence. Once the optimal cache size has been computed, the cache memory allocation can be modified based upon the optimal cache size.

A system for selecting a cache memory allocation to provide an optimized target cache hit rate can include a Zipf alpha coefficient parameter computation processor coupled to an optimal cache size computation processor communicatively linked to a caching component in a content delivery system. A communicative linkage between the Zipf alpha parameter computation processor and a server log storing statistics related to a hit rate for the cache can further be provided. Notably, the hit rate can be communicated to the Zipf alpha parameter computation processor over the communicative linkage.

Importantly, the Zipf alpha parameter computation processor can include programming for computing a Zipf alpha coefficient for a supplied hit rate, cache size and trace footprint according to the equation

$$HitRate = \frac{1 - {m}^{1 - α}}{1 - {T}^{1 - α}}$$

where α is the Zipf alpha coefficient, m is the cache size, T is the trace footprint and HitRate is the hit rate. Similarly, the optimal cache size computation processor can include programming for computing an optimal cache size for a supplied Zipf alpha coefficient, a preferred hit rate, and a known trace footprint according to the same equation

$$HitRate = \frac{1 - {m}^{1 - α}}{1 - {T}^{1 - α}}$$

where α is the Zipf alpha coefficient, m is the optimal cache size, T is the known trace footprint and HitRate is the preferred hit rate.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system configured for the autonomic selection of a cache size in a content delivery network based upon dynamically computed workload characteristics experienced in a caching component of the content delivery network; and,

FIG. 2 is a flow chart illustrating a process for autonomically selecting an optimal cache size in a caching component in the content delivery network based upon dynamically computed workload characteristics experienced in the content delivery network of FIG. 1.

### DETAILED DESCRIPTION OF THE PREFERRED EMBODIMENTS

The present invention is a method, system and apparatus for dynamically establishing an optimal cache size in a caching component of a content delivery network based upon computed workload characteristics. In accordance with the present invention, historically collected hit rate statistics can be retrieved in the content delivery network to determine a contemporarily experienced hit rate in the cache. The hit rate can include the rate at which requested content in the content delivery network can be served from the cache rather than from fixed storage. In addition to the hit rate, the contemporarily experienced request trace footprint can be determined as can a contemporary setting for the memory allocation in the cache.

A Zipf-alpha coefficient can be computed for the hit rate, footprint and memory allocation. Once the Zipf-alpha coefficient has been computed, a desired hit rate can be selected. Based upon the computed Zipf-alpha coefficient, the desired hit rate and the footprint, an optimal memory allocation for the cache can be computed. Once computed, the optimal memory allocation can be applied to the cache and the process can be performed again. In this way, the cache can self-configure repeatedly through the course of operation to ensure that the memory allocated for caching remains at an optimal level for a desired hit rate for the trace footprint experienced in the content delivery network

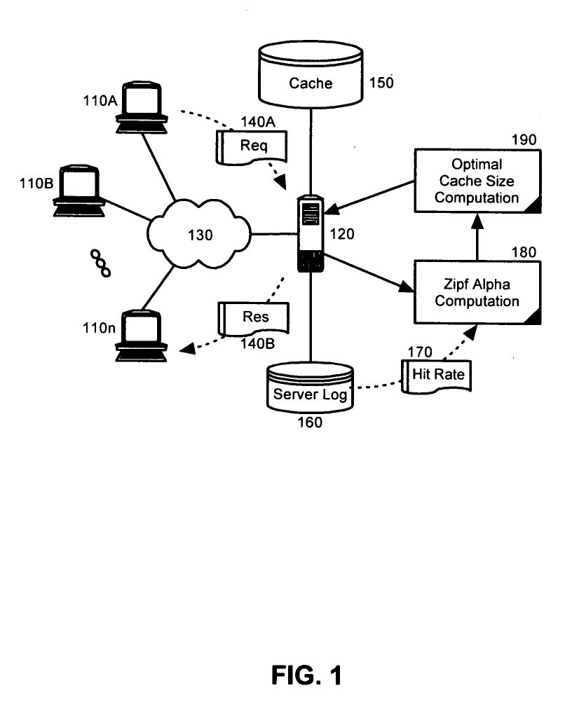

FIG. 1 is a schematic illustration of a system configured for the autonomic selection of a cache size in a caching component of a content delivery network based upon dynamically computed workload characteristics experienced in the content delivery network. The system can include one or more content consuming clients 110A, 110B, 110n communicatively linked to a content delivery server 120 over a computer communications network 130. The content delivery server 120 can respond to requests for content 140A, with responses 140B which can include the content requested within the requests 140A.

The content delivery server 120 can be coupled to a cache 150. The cache 150 can be allocated a fixed amount of memory in which the cache 150 can store frequently accessed content. The content delivery server 120 further can be coupled to a content delivery server log 160. The content delivery server log 160 can store therein statistics relating to the requests 140A processed in the content delivery server 120 and the responses 140B provided by the content delivery server 120 to the requests 140A.

Importantly, the content delivery server log 160 can include data suitable for computing a hit-rate associated with the cache 150. Specifically, through an inspection of the content delivery server log 160, a ratio can be determined for the number of requests 140A processed in the content delivery server 120 by serving content found in the cache 150 to requesting ones of the content consuming clients 110A, 110B, 110n, as compared to all content served by the content delivery server 120 to the content consuming clients 110A, 110B, 110n, regardless of whether the content is served from the cache, or from fixed storage.

Notably, although only a single content delivery server 120 is shown in the illustration of FIG. 1, it is to be understood that the invention is not so limited to a system incorporating only one content delivery server. In this regard, the system of the present invention also can be configured with multiple content delivery servers arranged in a server farm as is well known in the art. Alternatively, the system of the invention can include multiple independent content delivery servers. In all cases, however, either the individual content delivery servers, or a grouping of several content delivery servers can include memory allocated for caching responses to requests.

In accordance with the present invention, a Zipf alpha parameter computation processor 180 can be coupled to the content delivery server 120. The Zipf alpha parameter computation process 180 can be configured to solve the equation

$$HitRate = \frac{1 - {m}^{1 - α}}{1 - {T}^{1 - α}}$$

for the Zipf alpha coefficient based upon the known size (in objects) of the cache 150, the trace footprint (total objects in the request stream) contemporaneously experienced by the content delivery server 120, and the contemporaneously experienced hit rate 170 provided through an analysis of the server log 160. As it will be recognized by the skilled artisan, the foregoing equation represents a predicted cache hit rate for a trace of content requests based upon a known alpha coefficient and a known cache size as explained in the seminal paper, Lee Breslau, Pei Cao, Li Fan, Graham Phillips, Scott Shenker, Web Caching and Zipf-like Distributions: Evidence and Implications, Proceedings of IEEE Infocom '99 (March 1999).

The Zipf alpha computation processor 180 can be coupled to an optimal cache size computation processor 190. The optimal cache size computation processor 190 can be configured to solve the same Zipf equation above, this time solving for an unknown, optimal cache size based upon a preferred hit rate, the contemporaneously experienced trace footprint, and the Zipf alpha coefficient produced in the Zipf alpha computation processor 180. Using the optimal cache size produced by the optimal cache size computation processor 190, the memory allocated for the cache 150 can be adjusted to reflect the optimal cache size.

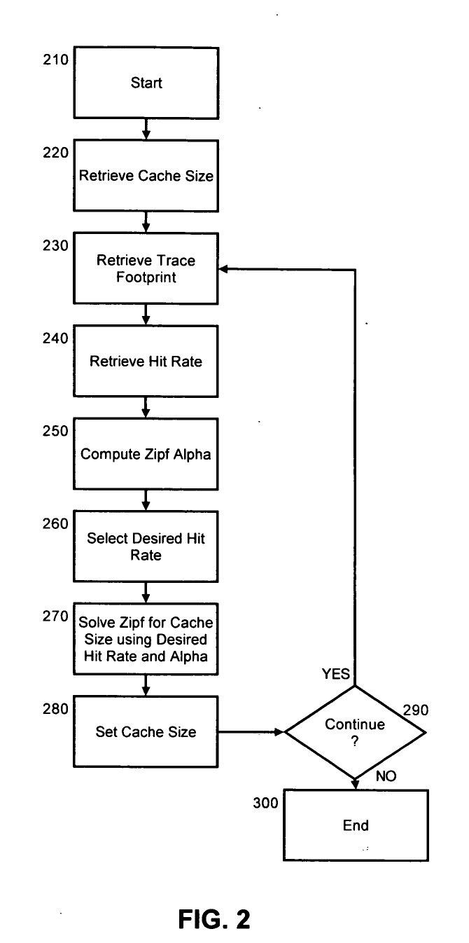

In more particular illustration of the foregoing methodology, FIG. 2 is a flow chart illustrating a process for autonomically selecting an optimal cache size for a caching component in a content delivery network based upon dynamically computed workload characteristics experienced in the content delivery network of FIG. 1. Beginning in block 210 and continuing in block 220, the current cache size can be retrieved for the system in terms of objects stored in the cache. In block 230, the currently experienced trace footprint can be retrieved in terms of number of objects in the request stream. In block 240, the server log for the content delivery server can be analyzed to compute a hit rate contemporaneously experienced in the cache.

In block 250, the Zipf equation can be solved based upon the retrieved elements to produce a computed value for the Zipf alpha coefficient. It is well known in the art to solve equations of the nature of the Zipf equation using Newton's iteration methodology, though any suitable method for solving for the Zipf alpha coefficient can suffice. In any case, in block 260 a preferred hit rate for the cache can be selected and in block 270 the Zipf equation once again can be solved for the optimal cache size using the known values: Zipf alpha coefficient; trace footprint and preferred hit rate. The resultant optimal cache size value can be applied to the cache in block 280.

Notably, the foregoing process can be repeatedly applied in blocks 230 through 290 (the cache size presumably will be known based upon the step performed in block 280) so as to maintain the self-configuring and self-healing aspects of an autonomically operated content delivery cache. As the Zipf alpha coefficient changes with the changing footprint of traces experienced in the content delivery server, so too can the optimal cache size. Accordingly, the content delivery server can behave autonomically in its constant configuration of the memory allocated for caching content in the content delivery system of FIG. 1.

It is to be understood that solving for the Zipf alpha coefficient to compute an optimal cache size to produce a desired hit rate within a single cache further can be applied to the partitioning of a cache to service multiple servers. Specifically, while the foregoing specification is directed to the circumstance of providing a single cache for a corresponding content server or content server farm, the system and methodology of the present invention can be equally applicable to the circumstance where a single cache supports multiple unrelated content servers. In this case, portions of the cache can be allocated to service different ones of the multiple unrelated content servers. Consequently, the hit rate characteristics for each of the different ones of the multiple unrelated content servers can be considered in computing the proper allocation of the cache memory for use in the single cache by the individual content servers.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for selecting a cache memory allocation to provide an optimized target cache hit rate in a caching component of a content delivery system, the method comprising the steps of:
identifying a current cache size and a contemporaneously experienced trace footprint;
determining a hit rate produced in response to said current cache size and said contemporaneously experienced trace footprint;
computing a Zipf alpha coefficient for said current cache size, trace footprint and hit rate;
selecting an optimal hit rate; and,
further computing an optimal cache size for said Zipf alpha coefficient, trace footprint and optimal hit rate.

2. The method of claim 1, further comprising the step of reconfiguring the cache memory allocation based upon said optimal cache size.

3. The method of claim 1, wherein said computing step comprises the step of computing said Zipf alpha coefficient based upon the equation
$$HitRate = \frac{1 - {m}^{1 - α}}{1 - {T}^{1 - α}}$$
where α is said Zipf alpha coefficient, m the known size of the cache, T is said trace footprint and HitRate is a contemporaneously experienced hit rate.

4. The method of claim 1, wherein said determining step comprises parsing a log of server activity to identify said hit rate.

5. The method of claim 1, wherein said identifying step comprises the step of identifying a current cache size and a contemporaneously experienced trace footprint for a cluster of servers.

6. The method of claim 1, wherein said identifying step comprises the step of identifying a current cache size and a contemporaneously experienced trace footprint for a single content delivery server.

7. A system for selecting a cache memory allocation to provide an optimized target cache hit rate in a caching component of a content delivery system, the system comprising a Zipf alpha coefficient parameter computation processor coupled to an optimal cache size computation processor communicatively linked to a cache in the content delivery system.

8. The system of claim 7, further comprising a communicative linkage between said Zipf alpha parameter computation processor and a server log storing statistics related to a hit rate for said cache over which said hit rate can be communicated to said Zipf alpha parameter computation processor.

9. The system of claim 7, wherein said Zipf alpha parameter computation processor comprises programming for computing a Zipf alpha coefficient for a supplied hit rate, cache size and trace footprint according to the equation
$$HitRate = \frac{1 - {m}^{1 - α}}{1 - {T}^{1 - α}}$$
where α is said Zipf alpha coefficient, m is said cache size, T is said trace footprint and HitRate is said hit rate.

10. The system of claim 7, wherein said optimal cache size computation processor comprises programming for computing an optimal cache size for a supplied Zipf alpha coefficient, a preferred hit rate, and a known trace footprint according to the equation
$$HitRate = \frac{1 - {m}^{1 - α}}{1 - {T}^{1 - α}}$$
where α is said Zipf alpha coefficient, m is said optimal cache size, T is said known trace footprint and HitRate is said preferred hit rate.

11. A machine readable storage having stored thereon a computer program for selecting a cache memory allocation to provide an optimized target cache hit rate in a caching component of a content delivery system, the computer program comprising a routine set of instructions which when executed cause the machine to perform the steps of:
identifying a current cache size and a contemporaneously experienced trace footprint;
determining a hit rate produced in response to said current cache size and said contemporaneously experienced trace footprint;
computing a Zipf alpha coefficient for said current cache size, trace footprint and hit rate;
selecting an optimal hit rate; and,
further computing an optimal cache size for said Zipf alpha coefficient, trace footprint and optimal hit rate.

12. The machine readable storage of claim 11, further comprising the step of reconfiguring the cache memory allocation based upon said optimal cache size.

13. The machine readable storage of claim 11, wherein said computing step comprises the step of computing said Zipf alpha coefficient based upon the equation
$$HitRate = \frac{1 - {m}^{1 - α}}{1 - {T}^{1 - α}}$$
where α is said Zipf alpha coefficient, m the known size of the cache, T is said trace footprint and HitRate is a contemporaneously experienced hit rate.

14. The machine readable storage of claim 11, wherein said determining step comprises parsing a log of server activity to identify said hit rate.

15. The machine readable storage of claim 11, wherein said identifying step comprises the step of identifying a current cache size and a contemporaneously experienced trace footprint for a cluster of servers.

16. The machine readable storage of claim 11, wherein said identifying step comprises the step of identifying a current cache size and a contemporaneously experienced trace footprint for a single content delivery server.
